(19) United States
(12) Patent Application Publication
(10) Pub. No.: US 2024/0378411 A1
(43) Pub. Date: Nov. 14, 2024

(54) SPIKE NEURAL NETWORK CIRCUIT AND OPERATION METHOD THEREOF

(71) Applicant: Electronics and Telecommunications Research Institute, Daejeon (KR)

(72) Inventors: Kwang Il Oh, Daejeon (KR); Tae Wook Kang, Daejeon (KR); Hyuk Kim, Daejeon (KR); Jae-Jin Lee, Daejeon (KR)

(73) Assignee: Electronics and Telecommunications Research Institute, Daejeon (KR)

(21) Appl. No.: 18/421,055

(22) Filed: Jan. 24, 2024

(30) Foreign Application Priority Data
May 9, 2023 (KR) 10-2023-0059717

(51) Int. Cl. G06N 3/04

(52) U.S. Cl. CPC G06N 3/04

(57) ABSTRACT

Disclosed is a spike neural network circuit, which includes an axon generating a spike input, a synapse performing a weight calculation and generating a membrane signal based on the weight calculation, and a neuron accumulating the membrane signal to generate a spike output, and the neuron includes a firing unit that compares a potential of a membrane node where the membrane signal is accumulated with a reference potential and fires based on the comparison result, membrane capacitors connected to the membrane node, a switch controller that outputs switching signals based on the firing of the firing unit, switches that connects each of membrane capacitors to one of a power supply voltage and a ground voltage in response to the switching signals, and a spike output generator that generates the spike output based on the plurality of switching signals and the firing of the firing unit.

### CROSS-REFERENCE TO RELATED APPLICATIONS

This application claims priority under 35 U.S.C. § 119 to Korean Patent Application No. 10-2023-0059717 filed on May 9, 2023, in the Korean Intellectual Property Office, the disclosures of which are incorporated by reference herein in their entireties.

### BACKGROUND

Embodiments of the present disclosure described herein relate to a spike neural network circuit, and more particularly, relate to a spike neural network circuit with an expanded membrane calculation operating range.

A Spike Neural Network (SNN) is a method of implementing an artificial intelligence network based on network calculations on inputs. Unlike other conventional artificial neural networks, the SNN does not receive input and transmit signals in values of a specific size, but performs calculations in the form of pulses or spikes with a very short time width.

The SNN may include an axon that applies input spikes of a specific period, a neuron that fires spike output, and a synapse that may perform network calculations of the relationship between input spikes and output spikes. The synapse may perform network calculations on received input spikes based on weights that define the relationship between stored input spikes and output spikes and may transfer a membrane signal as the result to the neuron. The neuron may generate the spike output by determining whether to fire based on the accumulation of membrane signals received from the synapse.

The above-described SNN may be implemented with a semiconductor circuit. In the SNN implemented as a semiconductor circuit using MOSFETs, synapse calculations may be implemented in the form of charge calculations. The synapse implemented as a semiconductor circuit may, for example, be implemented as the MOSFETs that receive a spike input to gate nodes and are connected between the neuron and weight data. When a spike network circuit with a semiconductor circuit is implemented, it is important to ensure that the current source may operate in the saturation region. To this end, a threshold voltage of the neuron may be set such that the membrane voltage does not rise excessively. This may result in the dynamic range of the membrane being limited. The limited dynamic range of the membrane may cause charge calculation errors, and the charge calculation errors may be severe when the weights stored in the synapse are large.

### SUMMARY

Embodiments of the present disclosure provide a device for improving the accuracy of charge calculations of a spike neural network while ensuring operation in a saturation region of current sources inside synapses and neurons.

According to an embodiment of the present disclosure, a spike neural network circuit includes an axon that generates a spike input, a synapse that performs a weight calculation in response to the spike input and generates a membrane signal based on the weight calculation, and a neuron that accumulates the membrane signal to generate a spike output, and the neuron includes a firing unit that compares a potential of a membrane node where the membrane signal is accumulated with a reference potential and fires based on the comparison result, a plurality of membrane capacitors connected to the membrane node, a switch controller that outputs a plurality of switching signals based on the firing of the firing unit, a plurality of switches that connects each of the plurality of membrane capacitors to one of a power supply voltage and a ground voltage in response to the switching signals, and a spike output generator that generates the spike output based on the plurality of switching signals and the firing of the firing unit.

According to an embodiment of the present disclosure, a method of operating a spike neural network circuit includes receiving, by a synapse, a spike input from an axon to generate a membrane signal based on a weight, accumulating the membrane signal on a membrane node of a neuron to lower a potential of the membrane node, when the potential of the membrane node becomes lower than a reference potential, generating, by a firing unit of the neuron, a firing signal by firing, generating, by a switch controller, switching signals for deactivating the membrane capacitors in response to the firing signal, and generating, by a spike output generator, a spike output based on the switching signals and the firing signal.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a spike neural network circuit.

FIG. 2 is a diagram illustrating a synapse of FIG. 1 in detail according to an embodiment of the present disclosure.

FIG. 3 is a diagram illustrating an I-DAC of FIG. 2 in detail, according to an embodiment of the present disclosure.

FIG. 4 is a diagram illustrating a neuron of FIG. 1 in detail.

FIG. 5 is a diagram illustrating a comparator of FIG. 4 in detail.

FIG. 6 is a timing diagram illustrating an operation of a spike neural network of FIG. 1.

FIG. 7 is a diagram illustrating a neuron of a spike network circuit of the present disclosure in detail.

FIG. 8 is a timing diagram illustrating an operation of a spike network circuit including a neuron of FIG. 7.

FIG. 9 is a diagram illustrating a switch controller and switches of FIG. 7 in detail, according to an embodiment of the present disclosure.

FIG. 10 is a diagram illustrating a switch controller of FIG. 9 in detail, according to an embodiment of the present disclosure.

FIG. 11 is a flowchart illustrating an order in which a neuron illustrated in FIG. 7 operates, according to an embodiment of the present disclosure.

### DETAILED DESCRIPTION

Hereinafter, embodiments of the present disclosure will be described clearly and in detail such that those skilled in the art may easily carry out the present disclosure.

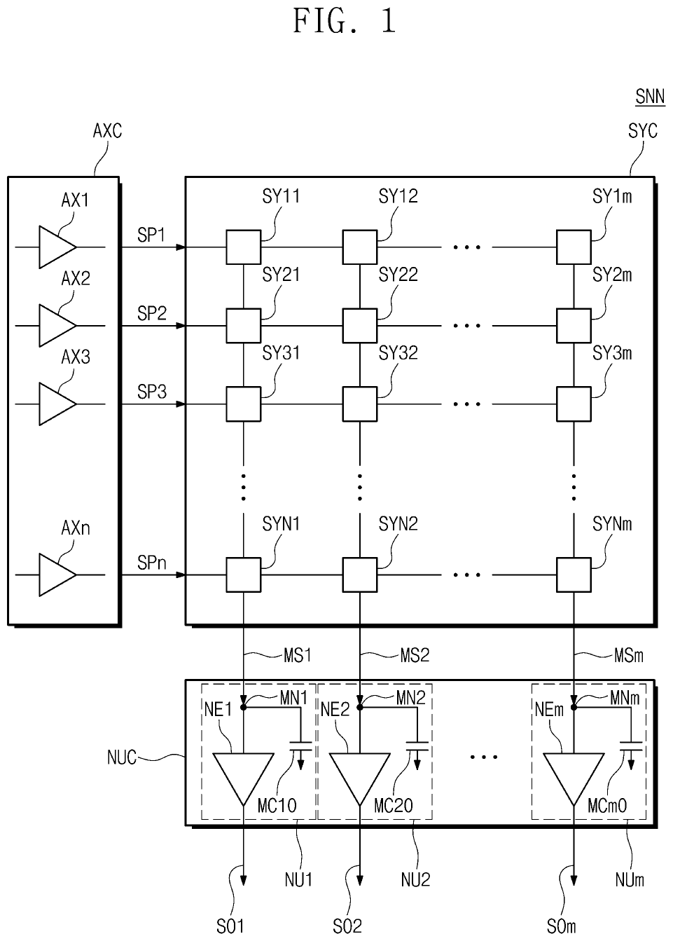

FIG. 1 is a diagram illustrating a spike neural network circuit. Referring to FIG. 1, a spike neural network SNN may include an axon circuit AXC, a synapse circuit SYC, and a neuron circuit NUC. For example, the spike neural network SNN may transfer spike inputs SP1 to SPn generated from the axon circuit AXC to the synapse circuit SYC. The synapse circuit SYC may perform a weight calculation based on the received spike inputs SP1 to SPn and stored weights, and may generate membrane signals MS1 to MSm that are the results of the calculation. The synapse circuit SYC may transfer the generated membrane signals MS1 to MSm to the neuron circuit NUC. The neuron circuit NUC may generate spike outputs SO1 to SOm based on the received membrane signals MS1 to MSm.

The axon circuit AXC may generate the spike inputs SP1 to SPn. In an embodiment, the axon circuit AXC may generate the n spike inputs SP1 to SPn. The axon circuit AXC may determine the degree of accumulation of the membrane signals MS1 to MSm in the neuron circuit NUC based on an application period of the input pulse. The axon circuit AXC may transfer the generated spike inputs SP1 to SPn to the synapse circuit SYC.

An axon circuit AXC may include a plurality of axons AX. Referring to FIG. 1, the axon circuit AXC may include n axons AX1 to AXn. Each of the n axons AX1 to AXn may independently generate corresponding spike inputs SP1 to SPn. The each axon AX1 to AXn may transfer the generated spike inputs SP1 to SPn to corresponding synapses SY11 to SYNM.

The synapse circuit SYC may generate the membrane signals MS1 to MSm that are the results of the calculation by calculating the spike inputs SP1 to SPn received from the axon circuit AXC through the synapses SY11 to SYNM. In an embodiment, the synapse circuit SYC may include the plurality of synapses SY11 to SYNM. For example, the synapse circuit SYC may include the plurality of synapses SY11 to SYNM that receive the N spike inputs SP1 to SPn and generate the M membrane signals MS1 to MSm. Referring to FIG. 1, the synapse circuit SYC may include the plurality of synapses SY11 to SYNM arranged in a grid N×M of N rows and M columns. The synapse circuit SYC may transfer the plurality of generated membrane signals MS1 to MSm to the neuron circuit NUC.

The each of the synapses SY11 to SYNM may generate calculation results, that is, the membrane signals MS1 to MSm, by applying the synapse weights to the spike inputs SP1 to SPn. The synapse weights may determine whether and how strong a connection is between a neuron NU and an axon AX. The each of the synapses SY11 to SYNM may transfer the generated membrane signals MS1 to MSm to corresponding neurons NU1 to NUm. For example, an m-th membrane signal MSm generated from a synapse SY1M of a first row and an M-th column may be transferred to the corresponding m-th neuron NEm.

The neuron circuit NUC may generate the spike outputs SO1 to SOm based on the membrane signals MS1 to MSm received from the synapse circuit SYC. Referring to FIG. 1, the neuron circuit NUC may include the plurality of neurons NU1 to NUm. The plurality of neurons NU1 to NUm may include firing units NE1 to NEm each connected to membrane nodes MN1 to MNm, and membrane capacitors MC10 to MCm0. For example, in the first membrane node MN1, the first firing unit NE1 and the first membrane capacitor MC10 may be connected to each other, and the plurality of synapses SY11 to SYN1 located in a first column of the synapse circuit SYC may be connected to the first membrane node MN1.

The membrane capacitor MC may store charges of the membrane node MN. Referring to FIG. 1, one end of membrane capacitors MC1 to MCm may be grounded, and the other end thereof may be connected to the corresponding membrane nodes MN1 to MNm. The membrane capacitor MC may store charges (or a current) contained in a membrane signal MS received from the synapse circuit SYC.

The firing units NE1 to NEm may fire based on a comparison of the potential value accumulated in each of the corresponding membrane capacitors MC10 to MCm0 with a threshold value. In an embodiment, a firing unit NE fires when the potential of a membrane node MN becomes lower than a threshold potential, thereby generating a spike output SO. In an embodiment, the firing unit NE fires when the potential of the membrane node MN becomes greater than the threshold potential, thereby generating the spike output SO.

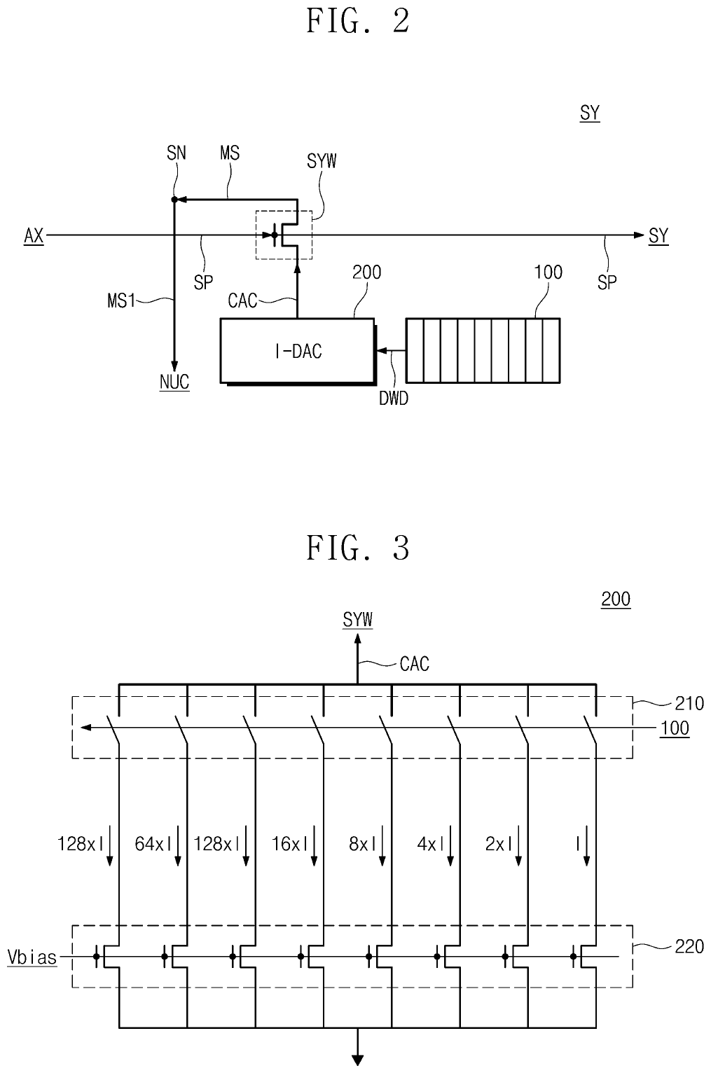

FIG. 2 is a diagram illustrating in detail a synapse SY within the synapse circuit SYC illustrated in FIG. 1. Through FIG. 2, the process of applying the synapse weight to a spike input SP received by the synapse SY from the axon AX will be described. Referring to FIG. 2, the synapse SY may include a memory 100, a current digital analog converter (I-DAC) 200, and a synapse calculator SYW.

The memory 100 may include weights of synapses. In an embodiment, the memory 100 may store weight data DWD of the synapses in the form of digital bits. For example, referring to FIG. 2, the memory 100 may store the weight data DWD in 8-bit format. The weight data DWD stored in the memory 100 may include information on whether there is a connection between the spike input SP and the membrane signal MS and the connection strength. The memory 100 may provide the weight data DWD to the current digital-to-analog converter 200. The above description is an example, and the size of the weight data DWD stored in the memory 100 may have various lengths in addition to 8-bit.

The current digital-to-analog converter 200 may convert digital weight data DWD provided from the memory 100 into analog data. In an embodiment, the current digital-to-analog converter 200 may convert the weight data DWD into an analog current CAC corresponding to the weight data DWD in digital format based on the size of the value of the weight data DWD. For example, when 4-bit weight data DWD such as 1010 is received, the current digital-to-analog converter 200 may generate 10 times the current as when receiving data such as 0001, thereby performing digital-to-analog conversion. A detailed operation of the current digital-to-analog converter 200 according to an embodiment of the present disclosure will be described later with reference to FIG. 3.

A synapse calculator SYW may perform the weight calculation on the received spike input SP. The synapse calculator SYW may receive the spike input SP provided from the axon AX as a first input. The synapse calculator SYW may receive the analog current CAC generated from the current digital-to-analog converter 200 as a second input. The synapse calculator SYW may perform the weight calculation based on the first input and the second input and may generate the membrane signal MS as a result. The generated membrane signal MS may be transferred to the corresponding neuron NU through a synapse node SN. For example, referring to FIG. 2, the synapse calculator SYW may be connected between the synapse node SN and the current digital-to-analog converter 200, and may be an NMOS receiving the spike input SP through a gate node.

FIG. 3 is a diagram illustrating the current digital-to-analog converter 200 illustrated in FIG. 2 in detail. Through FIGS. 2 and 3, the process of converting the weight data DWD into the analog current CAC will be described. Referring to FIG. 3, the current digital-to-analog converter 200 may include a plurality of switches 210 and a plurality of current sources 220. For example, according to the value of the weight data DWD, on-off of each of the plurality of switches 210 corresponding to the weight data DWD is determined, and the current generated from each current source 220 corresponding to the plurality of switches 210 may flow from the synapse calculator SYW.

The plurality of switches 210 may operate based on the weight data DWD. For example, when a value of the bit corresponding to a switch is ‘1’, the switch may be turned on, and when a value of the bit corresponding to the switch is ‘0’, the switch may be turned off. The number of individual switches within the plurality of switches 210 may correspond to the number of digits of bits of the weight data DWD. For example, when the weight data DWD is n-bit binary data, the plurality of switches 210 may include ‘n’ individual switches.

The plurality of current sources 220 may generate current that is the basis of the membrane signal MS. In an embodiment, the plurality of current sources 220 may be implemented with a plurality of NMOSs. For example, a bias voltage Vbias may be set on the gate nodes of the plurality of NMOSs to ensure operation in the saturation region of the plurality of current sources 220. Each of the plurality of NMOSs may be connected in parallel between a ground node and the switch.

In an embodiment, the plurality of current sources 220 may each be designed to generate a current that is a power-of-two multiple of a unit current. Referring to FIG. 3, the plurality of current sources 220 may be designed to generate 2 times, 4 times, 8 times, to 128 times the current with respect to the unit current ‘I’. For example, the NMOS inside the plurality of current sources 220 may be designed to have a W/L of a power-of-two multiple, based on the W/L value of the NMOS that generates a unit current. As a more detailed example, the NMOS may be designed to have 2 (W/L), 4 (W/L), to 128 (W/L).

The above description is described based on the case where the weight data DWD is 8-bit, but is not limited to thereto, and corresponding to various bit lengths according to the purpose of the SNN, the number of individual switches of the plurality of switches 210, the number of individual current sources of the plurality of current sources 220, and the magnitude of the generating current may be different.

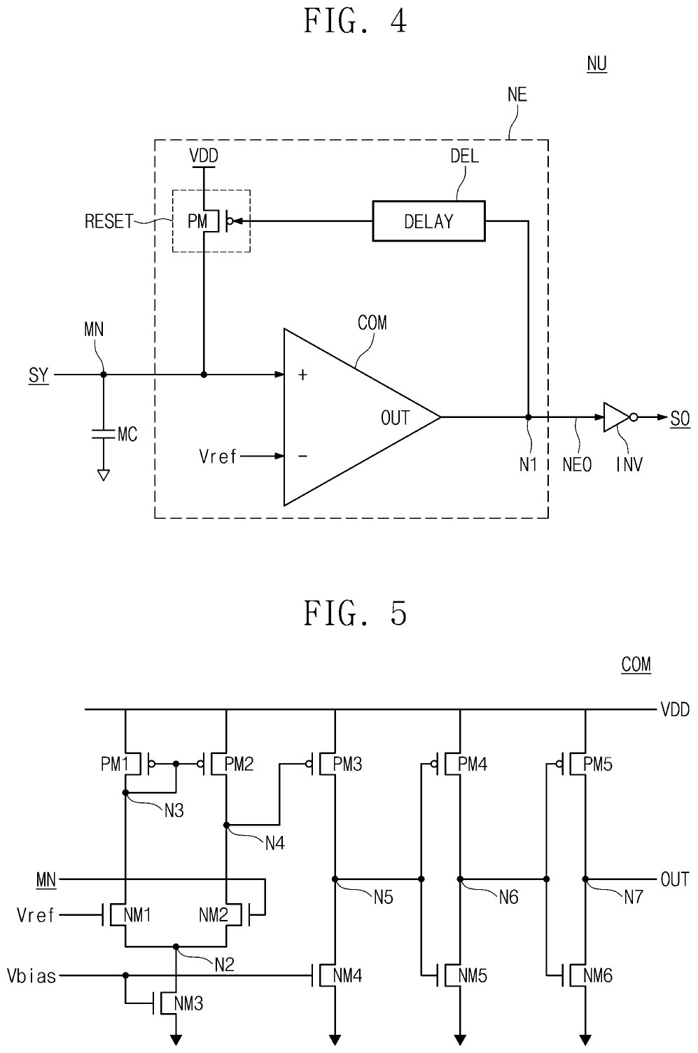

FIG. 4 is a diagram illustrating in detail one of the neurons NU1 to NUm within the neuron circuit NUC illustrated in FIG. 1, according to an embodiment of the present disclosure. Through FIG. 4, the process by which the neuron NU fires will be described. Referring to FIG. 4, the neuron NU may include the membrane capacitor MC, the firing unit NE, and an inverter INV. For example, when the potential of the membrane node MN becomes lower than a reference potential Vref, the neuron NU may generate a firing signal NEO of the firing unit NE and may invert the firing signal NEO through the inverter INV to generate a spike output. Hereinafter, each configuration and operation of the neuron NU will be described in detail.

The firing unit NE may perform firing of the neuron NU based on the potential of the membrane node MN. The firing unit NE may receive the potential of the membrane node MN as an input and may output the firing signal NEO. Referring to FIG. 4, the firing unit NE may include a comparator COM, a delay unit DEL, and an initialization unit RESET.

The comparator COM may compare the potential of the membrane node MN with the reference potential Vref and may control the firing based on the comparison result. Referring to FIG. 4, the membrane node MN may be connected to the non-inverting input node (+) of the comparator COM, and the reference potential Vref may be connected to the inverting input node (−) thereof. The output of the comparator COM may be provided to the inverter INV and the delay unit DEL through a first node N1. In an embodiment, the comparator COM may fire when the voltage of the membrane node MN is lowered compared to the reference potential Vref. For example, the comparator COM may output an output of ‘1’ when the potential of the membrane node MN is greater than the reference potential Vref, and may fire as ‘0’ when the potential of the membrane node MN is lower than the reference potential Vref. The output of the comparator COM may be provided as the firing signal NEO of the firing unit NE.

The delay unit DEL may delay the output of the comparator COM for a specific period of time so as to be transferred to the initialization unit RESET. Referring to FIG. 4, the delay unit DEL may be connected between the first node N1 and the initialization unit RESET. For example, the delay unit DEL may delay the output of the comparator COM for a specific period of time and then may transfer the output of the comparator COM to the initialization unit RESET.

The initialization unit RESET may initialize the potential of the membrane node MN to a specific voltage after the comparator COM fires. For example, when the delayed output of the comparator COM from the delay unit DEL is received, the initialization unit RESET may initialize the potential of the membrane node MN to a potential VDD of the power supply node. In an embodiment, the initialization unit RESET may include a PMOS ‘PM’. The PMOS PM may be connected between the power supply node and the membrane node MN, and may have a gate node connected to the delay unit DEL. When a comparator spike output is transferred as ‘0’, the PMOS PM is turned on, and the potential of the membrane node MN rises and may become equal to the potential VDD of the power supply node.

The inverter INV may invert the output of the firing unit NE. Referring to FIG. 4, an input of the inverter INV is connected to the first node N1, and an output of the inverter INV may be the spike output SO. Through the inverter INV, the neuron NU may invert the output of the comparator COM and may fire from ‘0’ to ‘1’.

The initialized neuron NU may again receive the membrane signal MS and may accumulate charges of the membrane signal MS in the membrane capacitor MC. The comparator COM may fire when the potential of the membrane node MN becomes lower than the reference potential Vref depending on the accumulated membrane signal MS. The neuron NU may repeat the above-described process.

FIG. 5 is a diagram illustrating the comparator COM illustrated in FIG. 4 in detail, according to an embodiment of the present disclosure. An example of implementing the comparator COM using a semiconductor circuit will be described through FIG. 5. Referring to FIG. 5, the comparator may include first to sixth NMOSs NM1 to NM6 and first to fifth PMOSs PM1 to PM5.

The first NMOS NM1 may be connected between a third node N3 and a second node N2 and may have a gate node connected to the reference potential Vref. The second NMOS NM2 may be connected between a fourth node N4 and a second node N2 and may have the membrane node MN as a gate node thereof. A pair of the first NMOS NM1 and the second NMOS NM2 may have the form of a differential amplifier, and may output a difference in voltage between the gate nodes of each NMOS.

The third NMOS NM3 may supply current to the first NMOS NM1 and the second NMOS NM2. The third NMOS NM3 may be connected between the second node N2 and the ground node and may have a gate node connected to the bias voltage Vbias. The third NMOS NM3 may operate as a current source when the bias voltage Vbias is uniform.

The first PMOS PM1 may be connected between the power supply node and the third node N3 and may have a gate node connected to the third node N3. The second PMOS PM2 may be connected between the power supply node and the fourth node N4 and may have a gate node connected to the third node N3. The first PMOS PM1 and the second PMOS PM2 may provide high impedance loads to the first NMOS NM1 and the second NMOS NM2, respectively.

The third PMOS PM3 may be connected between the power supply node and the fifth node N5, and may have a gate node connected to the fourth node N4. The fourth NMOS NM4 may be connected between the ground node and the fifth node N5, and may have a gate node connected to the bias voltage Vbias. The third PMOS PM3 may function as a common source amplifier CS AMP to amplify the signal of the fourth node N4 so as to be provided to the fifth node N5.

The fourth PMOS PM4 may be connected between the power supply node and a sixth node N6, and may have a gate node connected to the fifth node N5. The fifth NMOS NM5 may be connected between the ground node and the sixth node N6, and may have a gate node connected to the fifth node N5. A pair of the fourth PMOS PM4 and the fifth NMOS NM5 may operate as an inverter with an input connected to the fifth node N5 and an output connected to the sixth node N6.

The fifth PMOS PM5 may be connected between the power supply node and the seventh node N7, and may have a gate node connected to the sixth node N6. The sixth NMOS NM6 may be connected between the ground node and the seventh node N7, and may have a gate node connected to the sixth node N6. A pair of the fifth PMOS PM5 and the sixth NMOS NM6 may operate as an inverter with an input connected to the sixth node N6 and an output connected to the seventh node N7. The seventh node N7 may be connected to an output node OUT of the comparator COM.

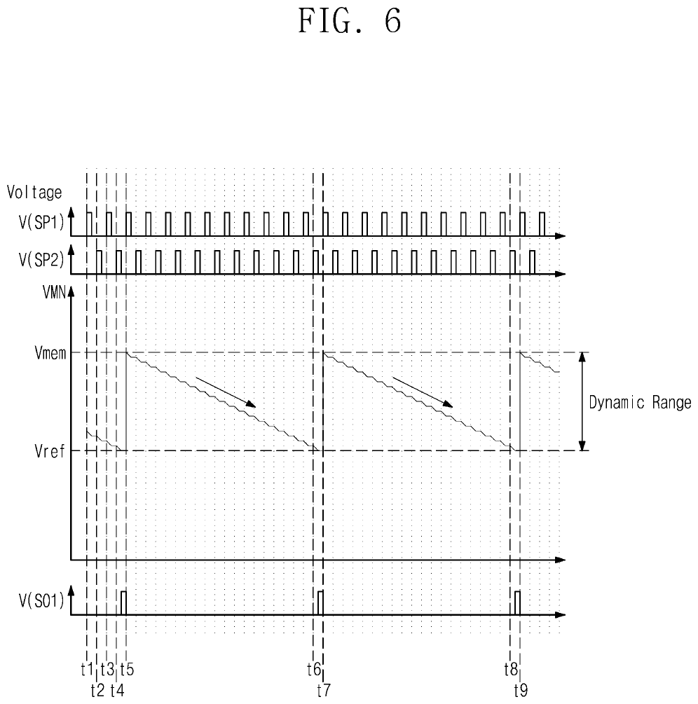

FIG. 6 is a timing diagram illustrating the process by which the neuron NU illustrated in FIG. 1 fires and is initialized. Through FIGS. 1 and 6, the process of generating the spike output SO depending on the input of the axon circuit AXC will be described. Referring to FIGS. 1 and 6, the voltage changes over time of the first spike input SP1, the second spike input SP2, the potential of the membrane node MN, and a first spike output SO1 are illustrated.

The first spike input SP1 may generate a spike at a first time t1 and then may maintain a LOW state from a second time t2 to a third time t3. The first spike input SP1 may periodically repeat the process from the first time t1 to the third time t3.

The second spike input SP2 may maintain the LOW state from the first time t1 to the second time t2, and may generate a spike at the second time t2, and then may be in the LOW state before reaching the third time t3. The second spike input SP2 may periodically repeat the process from the first time t1 to the third time t3.

The potential of the membrane node MN may decrease by a specific unit when a spike is generated from the first spike input SP1 or the second spike input SP2. This is the result of a decrease in the potential of the membrane capacitor MC according to a membrane signal MS1 generated by the synapse SY11 or SY21 connected to a first neuron NU1.

The first neuron NU1 may generate a spike when the potential of the membrane node MN becomes equal to the reference potential Vref. In this case, the first neuron may generate the first spike output SO1. For example, referring to FIG. 6, the potential of the membrane node MN becomes equal to the reference potential Vref at between a fourth time t4 and a fifth time t5, and in this case, the first spike output SO1 may be generated.

After the spike output SO is generated, the potential of the membrane node MN may be initialized to the initial voltage Vmem. The initialization process may be performed through the delay unit DEL and the initialization unit RESET illustrated in FIG. 4. For example, referring to FIG. 6, after the first spike output SO1 is generated in the first neuron NU1, the potential of the membrane node MN is initialized at the fifth time t5, and may be raised to an initial voltage Vmem.

Referring to FIG. 6, the potential of the membrane node MN may decrease depending on the spike input SP1 or SP2 from the fifth time t5 to a sixth time t6. When the potential of the membrane node MN becomes equal to the reference potential Vref, the spike output SO as described above may be generated, and at a seventh time t7, the potential of the membrane node MN may be initialized to an initial state.

The above-described process may be repeated at an eighth time t8 and a ninth time t9, and when the spike input SP1 or SP2 is applied as a periodic spike, the spike output SO that is periodically repeated may be generated.

Referring to FIG. 6, a dynamic range may be defined as the difference between the initial voltage Vmem and reference potential Vref. When the dynamic range is limited, errors in charge calculation may occur. When the dynamic range is increased by artificially lowering the reference potential Vref, the current source included in the synapse SY may not operate in the saturation region, which may cause a problem in that it may not function as the current source. A device of the present disclosure that may prevent these problems and may increase dynamic range will be described in detail below.

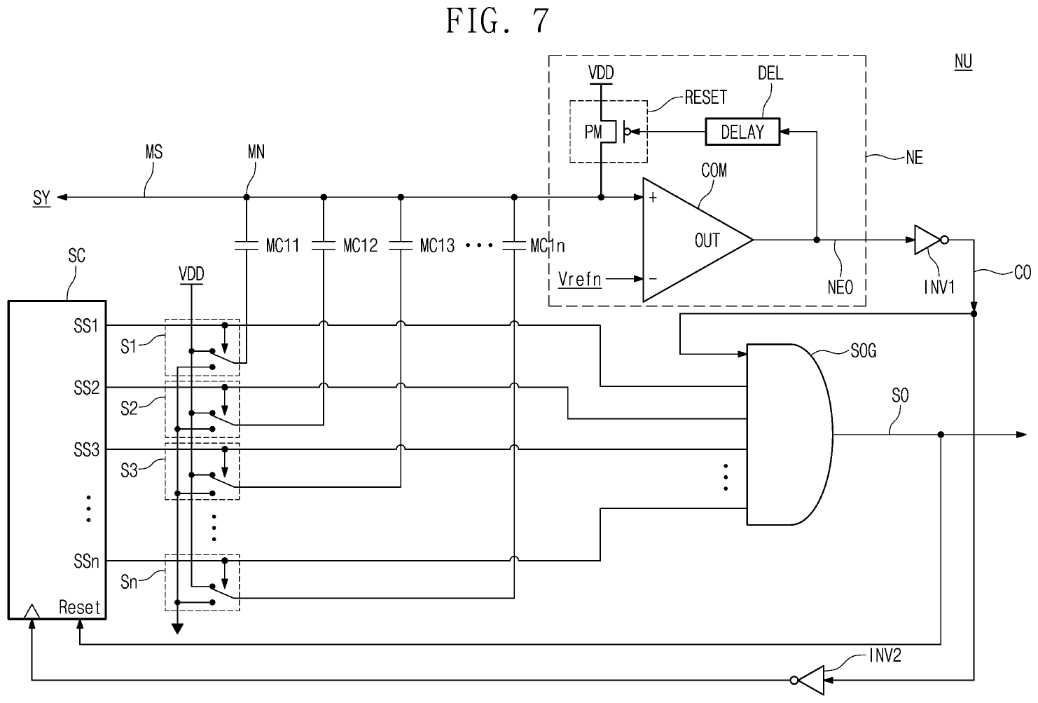

FIG. 7 is a diagram illustrating in detail one neuron NU included in the neuron circuit NUC illustrated in FIG. 1, according to an embodiment of the present disclosure. Through FIG. 7, the structure and operating principle of the device for expanding the dynamic range are described in detail. Referring to FIG. 7, the neuron NU may include a plurality of membrane capacitors MC11 to MC1n, the firing unit NE, a first inverter INV1, a second inverter INV2, a switch controller SC, and a spike output generator SOG. The structure and operation of the firing unit NE are described in detail with reference to FIG. 4, so additional description will be omitted below to avoid redundancy.

The plurality of membrane capacitors MC11 to MC1n may include a plurality of individual membrane capacitors. Referring to FIG. 7, one end of the plurality of membrane capacitors MC11 to MC1n may be connected to the membrane node MN, and the other end may be connected to switches S1 to Sn corresponding to each of the plurality of membrane capacitors MC11 to MC1n in parallel. In an embodiment, the electric capacitances of individual membrane capacitors of the plurality of membrane capacitors MC11 to MC1n may all be the same. For example, the electric capacitance of each membrane capacitor of the plurality of membrane capacitors MC11 to MC1n may be expressed in Equation 1.

$$\overline{{C}_{n} = \frac{C}{n}} \qquad [ Equation 1 ]$$

In Equation 1, CₙCₙ is the electrical capacitance of the individual membrane capacitor, ‘n’ is the number of individual membrane capacitors, and ‘C’ is the electrical capacitance of the membrane capacitor when a single membrane capacitor is connected to the membrane node.

The firing unit NE may fire based on the potential of the membrane node MN. The size of a reference potential Vrefn input to the inverting input node (−) of the comparator COM inside the firing unit NE is the same as Equation 2.

$$\overline{{Vref}_{n} = \frac{( n - 1 ) VDD}{n}} \qquad [ Equation 2 ]$$

In Equation 2, ‘n’ refers to the number of individual membrane capacitors of the plurality of membrane capacitors MC11 to MC1n, and the VDD refers to the voltage of the power source node in the SNN. The structure and operation of the comparator COM are the same as those described above with reference to FIG. 4, so additional descriptions will be omitted to avoid redundancy.

The first inverter INV1 may invert the firing signal NEO of the firing unit NE. The first inverter INV1 may receive the firing signal NEO as an input. The output node of the first inverter INV1 may be connected to one of the plurality of inputs of the spike output generator SOG and may be connected to the input node of the second inverter INV2. The first inverter INV1 may generate a temporary output CO based on the firing signal NEO.

The second inverter INV2 may invert the temporary output CO. The second inverter INV2 may receive the output of the first inverter INV1 as an input. The output node of the second inverter INV2 may be connected to a clock node of the switch controller SC.

The switch controller SC may select a membrane capacitor to be activated from the plurality of membrane capacitors MC11 to MC1n. Referring to FIG. 7, the switch controller SC may be connected to a plurality of switches S1 to Sn corresponding to output nodes SS1 to SSn, respectively. The switch controller SC may transmit switching signals to the corresponding switches S1 to Sn through the output nodes SS1 to SSn, such that the switches S1 to Sn are operated.

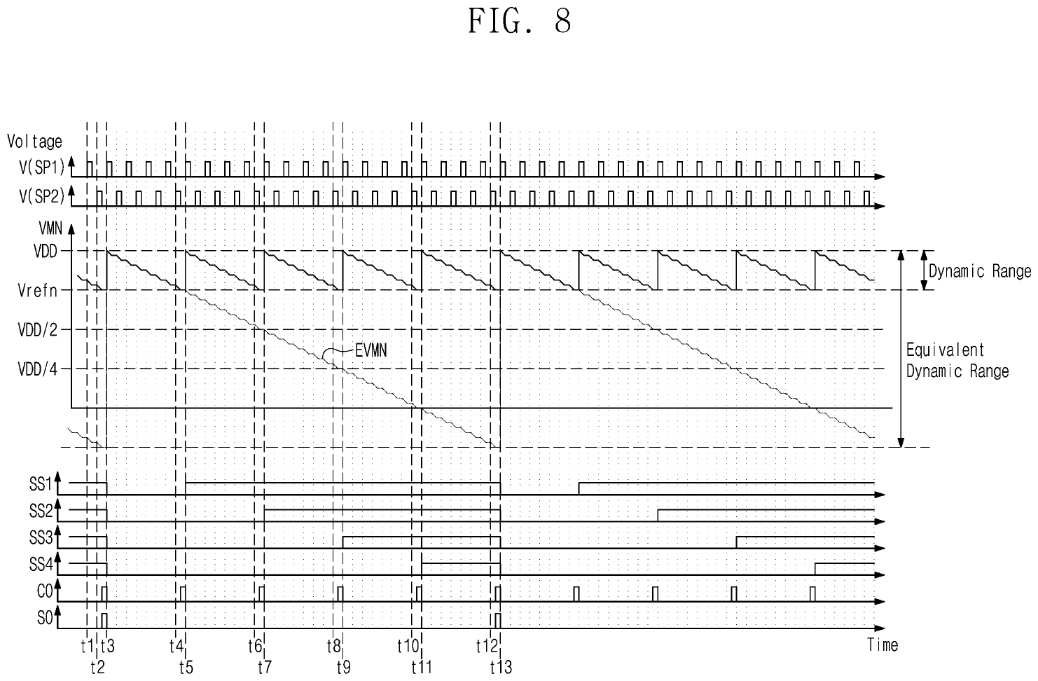

The switch controller SC may change the output nodes SS1 to SSn to transmit switching signals based on the clock signal. For example, referring to FIG. 7, the switch controller SC may change the output nodes SS1 to SSn to transmit switching signals in response to the output of the second inverter INV2. Referring to FIG. 7, the switch controller SC may use the spike output SO as an initialization signal. The detailed operation of the switch controller SC will be described in detail later with reference to FIG. 8.

The switches S1 to Sn may be connected to one end of the corresponding plurality of membrane capacitors MC11 to MC1n. The switches S1 to Sn may operate based on the switching signals of the corresponding output nodes SS1 to SSn of the switch controller SC. For example, referring to FIG. 7, the first switch S1 may connect one end of each of the plurality of corresponding membrane capacitors MC11 to MC1n to one of the power supply node and the ground node based on the switching signal of the first output node SS1 of the switch controller SC. The second switch S2 to the n-th switch Sn may also operate in the same manner as described above.

The spike output generator SOG may generate the spike output SO based on the output signals of the switch controller SC and the temporary output CO. Referring to FIG. 7, the spike output generator SOG may receive the temporary output CO and the switching signals of the output nodes SS1 to SSn of the switch controller SC as the inputs. The spike output generator SOG may generate the spike output SO based on the inputs described above. For example, when the temporary output CO is in a HIGH state and all output nodes SS1 to SSn of the switch controller SC provide the switching signals, the spike output generator SOG may generate the spike output SO.

FIG. 8 is a timing diagram illustrating an operation of the neuron NU over time when the neuron NU illustrated in FIG. 7 includes four membrane capacitors (i.e., MC11 to MC14), according to an embodiment of the present disclosure. Through FIGS. 7 and 8, the operation process and effects of the neuron NU according to an embodiment of the present disclosure will be described in detail. Referring to FIG. 8, changes in voltage of the first spike input SP1, the second spike input SP2, the potential of the membrane node MN, the potential of the equivalent membrane node EVMN, the potential of output nodes SS1 to SS4 of the switch controller SC, and the spike output CO are illustrated over time.

The first spike input SP1 may change to the HIGH state by generating a spike at the first time t1, and then may return to the LOW state before reaching the second time t2. The first spike input SP1 may maintain the LOW state from the second time t2 to the third time t3. The first spike input SP1 may periodically repeat the process from the first time t1 to the third time t3.

The second spike input SP2 may maintain the LOW state from the first time t1 to the second time t2 and then change to the HIGH state by generating a spike at the second time t2. The second spike input SP2 may change to the LOW state before reaching the third time t3. The second spike input SP2 may periodically repeat the process from the first time t1 to the third time t3.

At between the second time t2 and the third time t3, as a potential VMN of the membrane node MN becomes equal to the reference potential Vrefn, the comparator COM may fire, and may generate the temporary output CO through the first inverter INV1. In this case, since there are four membrane capacitors MC11 to MC14, the reference potential Vrefn may be 0.75 VDD obtained by substituting n=4 in Equation 2.

At between the second time t2 and the third time t3, since the output nodes SS1 to SS4 of the switch controller SC are all HIGH, and the value of the temporary output CO is also HIGH, the spike output generator SOG may generate the spike output SO as the output.

At the third time t3, based on the generated spike output SO, the switch controller SC may be initialized. All output nodes SS1 to SS4 of the switch controller SC may be switched from the HIGH state to the LOW state. Based on the operation of the initialization unit RESET, the potential VMN of the membrane node MN may be initialized to the potential VDD of the power supply node. At the third time t3, the magnitude of charges charged across the plurality of membrane capacitors may be expressed in Equation 3.

$$\overline{{Q}_{MEM} = {C}_{n} \times VDD \times 4} \qquad [ Equation 3 ]$$

In Equation 3, Q_{MEM}Q_{MEM} refers to the amount of charges stored in the plurality of membrane capacitors MC11 to MC14 included in the membrane node MN, and C̅ₙ̅C̅ₙ̅ refers to the electric capacitance of each of the plurality of membrane capacitors MC11 to MC14. The VDD is a voltage of the power supply node, and in this embodiment, is the same value as the initial value of the potential VMN of the membrane node MN. As the switch controller SC is initialized, all four membrane capacitors MC11 to MC14 may be activated and operated.

At between the third time t3 and the fourth time t4, the synapse SY may receive the first spike input SP1 or the second spike input (SP2) and may generate the membrane signal MS based on the weight calculation. The charges charged in the plurality of membrane capacitors MC11 to MC14 may be continuously discharged based on the membrane signal MS. As the potential VMN of the membrane node MN is continuously discharged, the potential VMN may continuously decrease.

At between the fourth time t4 and the fifth time t5, the potential VMN of the membrane node MN may become equal to the reference potential Vrefn due to continuous discharge. In this case, the firing unit NE may fire to generate the firing signal NEO and may generate the temporary output CO through the first inverter INV1. Since all output nodes SS1 to SS4 of the switch controller SC are not HIGH, the spike output generator SOG does not generate the spike output SO.

At the fifth time t5, the potential of the membrane node MN may be initialized to the potential VDD of the power supply node based on the operations of the delay unit DEL and the initialization unit RESET. The switch controller SC may switch the first output node SS1 of the switch controller SC to the HIGH state based on the clock signal generated by the temporary output CO passing through the second inverter INV2. Accordingly, the first membrane capacitor MC11 may be deactivated.

The amount of charge stored in the plurality of membrane capacitors MC11 to MC14 at the fifth time t5 is given as illustrated in Equation 4.

$$\overline{{Q}_{MEM} = {C}_{n} \times VDD \times 3} \qquad [ Equation 4 ]$$

Equation 4, unlike Equation 3, is expressed in a form in which three membrane capacitors are charged. This is because as the first output node SS1 of the switch controller SC changes to the HIGH state, the potential at both ends of the first membrane capacitor MC11 is the same, so charges are not charged. In detail, charges may be charged in the second membrane capacitor MC12, the third membrane capacitor MC13, and the fourth membrane capacitor MC14.

At between the fifth time t5 and the sixth time t6, discharge may continuously occur at the membrane node MN in the same manner as between the third time t3 and the fourth time t4. However, since there is no charge in the first membrane capacitor MC11, discharge may occur only in the remaining membrane capacitors MC12, MC13, and MC14 excluding the first membrane capacitor MC11.

At between the sixth time t6 and the seventh time t7, the firing unit NE may fire in the same manner as the operation between the fourth time t4 and the fifth time t5, and may generate the temporary output CO through the first inverter INV1. As at the fourth time t4 and the fifth time t5, since all output nodes SS1 to SS4 of the switch controller SC are not in the HIGH state, the spike output generator SOG does not generate the spike output SO.

At the seventh time t7, the potential VMN of the membrane node MN may be initialized to the potential VDD of the power supply node based on the operations of the delay unit DEL and the initialization unit RESET. The switch controller SC may switch the second output node SS2 of the switch controller SC to the HIGH state based on the clock signal generated by the temporary output CO passing through the second inverter INV2. Through this, the second membrane capacitor MC12 may be deactivated.

The amount of charge stored in the plurality of membrane capacitors MC11 to MC14 at the seventh time t7 is as illustrated in Equation 5.

$$\overline{{Q}_{MEM} = {C}_{n} \times VDD \times 2} \qquad [ Equation 5 ]$$

In Equation 5, unlike Equation 4, the product of the capacitance and voltage is multiplied by 2, which is the number of membrane capacitors, which means that since the first output node SS1 and the second output node SS2 of the switch controller SC are in the HIGH state, charges are not stored. Therefore, one side of the remaining two membrane capacitors (i.e., MC13 and MC14) is connected to the ground node, and the other side may have the potential VDD of the power supply node, which is the potential of the membrane node VMN. Therefore, the amount of charge stored in the two membrane capacitors MC13 and MC14 may be the amount of charge stored in the membrane node MN.

At between the seventh time t7 and the eighth time t8, the membrane capacitors MC11 to MC14 may be discharged in the same manner as between the fifth time t5 and the sixth time t6. However, since the two membrane capacitors MC11 and MC12 are not charged, discharge may only occur in the third membrane capacitor MC13 and the fourth membrane capacitor MC14.

At between the eighth time t8 and the ninth time t9, the firing unit NE may fire in the same manner as the operation between the sixth time t6 and the seventh time t7, and may generate the temporary output CO through the first inverter INV1. As at the sixth time t6 and the seventh time t7, since all output nodes SS1 to SS4 of the switch controller SC are not in the HIGH state, the spike output generator SOG does not generate the spike output SO.

At the ninth time t9, based on the operations of the delay unit DEL and the initialization unit RESET, the potential of the membrane node MN may be initialized to the potential VDD of the power supply node. The switch controller SC may switch the third output node SS3 of the switch controller SC to the HIGH state based on the clock signal generated by the temporary output CO passing through the second inverter INV2.

The amount of charge stored in the plurality of membrane capacitors MC11 to MC14 at the ninth time t9 is as illustrated in Equation 6.

$$\overline{{Q}_{MEM} = {C}_{n} \times VDD \times 1} \qquad [ Equation 6 ]$$

In Equation 6, unlike Equation 5, the product of the capacitance and voltage is multiplied by ‘1’, which is the number of membrane capacitors, which means that since the first output node SS1, the second output node SS2, and the third output node SS3 of the switch controller SC are all in the HIGH state, charges are not stored in the first membrane capacitor MC11, the second membrane capacitor MC12, and the third membrane capacitor MC13. Accordingly, one end of the fourth membrane capacitor MC14 is connected to the ground node, and the other end may have the potential VDD of the power supply node, which is the potential VMN of the membrane node MN. Accordingly, the amount of charge stored in the fourth membrane capacitor MC14 may be the amount of charge stored in the membrane node MN.

At between the ninth time t9 and a tenth time t10, the plurality of membrane capacitors MC11 to MC14 may be discharged in the same manner as between the seventh time t7 and the eighth time t8. However, since the three membrane capacitors MC11 to MC13 are not charged, discharge may only occur in the fourth membrane capacitor MC14.

At between the tenth time t10 and an eleventh time t11, the firing unit NE may fire in the same manner as the operation between the eighth time t8 and the ninth time t9, and may generate the temporary output CO through the first inverter INV1. As in the case between the eighth time t8 and the ninth time t9, since all output nodes SS1 to SS4 of the switch controller SC are not in the HIGH state, the spike output generator SOG does not generate the spike output SO.

At the eleventh time t11, based on the operations of the delay unit DEL and the initialization unit RESET, the potential of the membrane node MN may be initialized to the potential VDD of the power supply node. The switch controller SC may switch the fourth output node SS4 of the switch controller SC to the HIGH state based on the clock signal generated by the temporary output CO passing through the second inverter INV2. Since the output nodes of the plurality of membrane capacitors MC11 to MC14 are all connected through the switch controller SC in the HIGH state, the amount of charge stored in the plurality of membrane capacitors MC11 to MC14 may be ‘0’.

At between the eleventh time t11 and a twelfth time t12, discharge may occur at the membrane node MN based on the generated membrane signal MS. Since there is no charge stored in the plurality of membrane capacitors MC11 to MC14, discharge may occur in the form of accumulating negative charges in the plurality of membrane capacitors MC11 to MC14.

At between the twelfth time t12 and a thirteenth time t13, the comparator COM may fire in the same manner as the operation between the eighth time t8 and the ninth time t9, and may generate the temporary output CO through the first inverter INV1. Since all output ends SS1 to SS4 of the switch controller SC are in the HIGH state and the temporary output CO is in the HIGH state, all inputs of the spike output generator SOG may be in the HIGH state. At between the twelfth time t12 and the thirteenth time t13, the spike output generator SOG may generate the spike output SO.

At the thirteenth time t13, the neuron NU may operate the same as at the third time t3. The neuron NU may repeat the process from the third time t3 to the thirteenth time t13.

Although intervals of between the third time t3 and the fourth time t4, between the fifth time t5 and the sixth time t6, the seventh time t7 and the eighth time t8, between the ninth time t9 and the tenth time t10, and the eleventh time t11 and the twelfth time t12, in the timing diagram illustrated in FIG. 8, that is, the intervals of time when discharge occurs at the membrane node MN are all illustrated to be the same, an embodiment of the present disclosure is not limited thereto, and the time at which the potential VMN of the membrane node NM becomes equal to the reference potential Vrefn may be different.

Referring to FIG. 8, the neuron NU according to an embodiment of the present disclosure may have an equivalent dynamic range. The equivalent membrane node potential EVMN may decrease from VDD to −VDD/4. Therefore, the equivalent dynamic range may have a range that is five times wider than the dynamic range based on the output of the comparator. Additionally, by maintaining the reference potential above a specific level, the current source included in the synapse circuit SYC and neuron circuit NUC may be guaranteed to operate within the saturation region, thereby improving the accuracy of charge calculation.

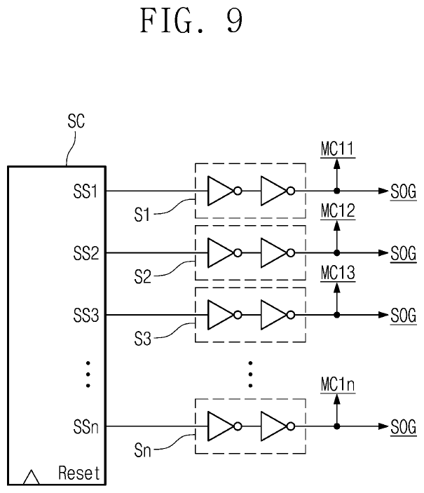

FIG. 9 is a diagram illustrating in detail the switch controller SC and the switches S1 to Sn of FIG. 7 according to an embodiment of the present disclosure. Through FIG. 9, an embodiment for specifically implementing the switches S1 to Sn is described. Referring to FIG. 9, the switches S1 to Sn may include two inverters connected in series.

The switches S1 to Sn may transfer the switching signal of the output nodes SS1 to SSn of the switch controller SC to one end of the corresponding membrane capacitors MC11 to MC1n. This is because two inverters are connected in series and serve as a buffer. For example, when the switching signal of the first output node SS1 of the switch controller SC is in the LOW state, the first switch S1 may transfer the LOW to the spike output generator SOG. In the same case, the first switch S1 may turn one end of the first membrane capacitor MC11 to the LOW. In an embodiment, the LOW of the switch controller SC may provide the ground voltage, and the HIGH of the switch controller SC may provide the potential VDD of the power supply node. Like the first switch S1, the second to n-th switches S2 to Sn may also be implemented in the same way.

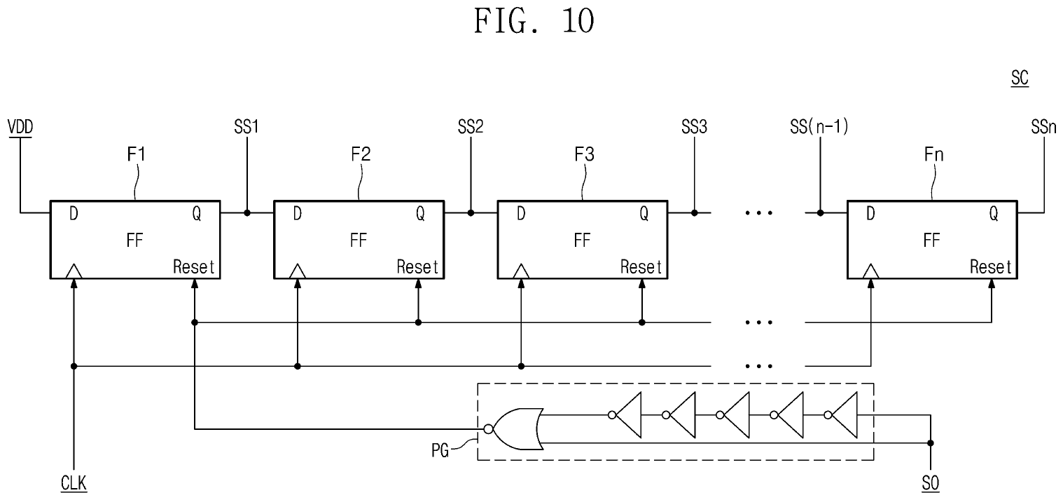

FIG. 10 is a diagram illustrating the switch controller SC illustrated in FIGS. 7 and 9 in detail, according to an embodiment of the present disclosure. Through FIG. 10, the operation of the switch controller SC according to an embodiment of the present disclosure will be described. Referring to FIG. 10, the switch controller SC may include a pulse generator PG and a plurality of flip-flops F1 to Fn.

The pulse generator PG may generate a reset signal of the plurality of flip-flops F1 to Fn based on the spike output SO. In an embodiment, the pulse generator PG may be configured based on a NOR gate. For example, referring to FIG. 10, the NOR gate included in the pulse generator PG may have the spike output SO and an output obtained by passing the spike output SO through five series inverters as inputs. The NOR gate may transfer an initialization signal of each of the plurality of flip-flops F1 to Fn as an output thereof.

The pulse generator PG may cause the plurality of flip-flops F1 to Fn to be initialized at the falling edge of the spike output SO. However, the scope of the present disclosure is not limited thereto, and any structure capable of forming an initialization pulse in accordance with the falling edge based on the spike output SO may be included in the scope of the present disclosure.

The plurality of flip-flops F1 to Fn may store and output the received input value in response to the clock, and may provide the output to the output nodes SS1 to SSn of the switch controller SC. In an embodiment, the plurality of flip-flops F1 to Fn may be D flip-flops.

Referring to FIG. 10, the D input of the first flip-flop F1 may be connected to the power supply node. The Q output of the first flip-flop F1 may be connected to the D input of the second flip-flop F2 and may be the first output node SS1 of the switch controller SC. Likewise, the Q output of the second flip-flop F2 may be connected to the D input of the third flip-flop F3 and may be the second output node SS2 of the switch controller SC. This may be connected equally up to the (n−1)-th flip-flop Fn−1. The n-th flip-flop Fn may have the Q output of the (n−1)-th flip-flop Fn−1 as the D input, and may have the n-th output node SSn of the switch controller SC as the Q output.

In an embodiment, the plurality of flip-flops F1 to Fn may use the same signal as the output of the comparator COM illustrated in FIG. 7 as a clock signal. (In FIG. 7, it is illustrated as passing through two inverters.) In an embodiment, the plurality of flip-flops F1 to Fn may use the output of the pulse generator PG as the reset signal.

With reference to FIGS. 7, 8, and 10, the operation process of the switch controller SC illustrated in FIG. 10 will be described. The temporary output CO illustrated in FIG. 7 may be provided to a clock node of the switch controller SC of FIGS. 7 and 10 in an inverted form through the second inverter INV2. In detail, the plurality of flip-flops F1 to Fn inside the switch controller SC may use the inverted signal of the temporary output CO as the clock signal.

At the fifth time t5, as the temporary output CO changes from HIGH to LOW, the clock signal may indicate a rising edge. The first flip-flop F1 may transfer the HIGH state (VDD in FIG. 10) received through the D input to the Q output. In this case, the first output node SS1 of the switch controller SC may also output the HIGH signal. Next, at the seventh time t7 when the rising edge of the clock appears, the second flip-flop F2 may transfer the HIGH D input received from the Q output of the first flip-flop F1 to the Q output. In this case, the second output node SS2 of the switch controller SC may output the HIGH signal. This process may be performed similarly at the ninth time t9 and the eleventh time t11.

FIG. 8 is an example of the case where the four membrane capacitors MC11 to MC14 are included and the switch controller SC also includes four output nodes SS1 to SS4, so at the thirteenth time t13, all initializations may be done based on the spike output SO. Based on the number of membrane capacitors MC11 to MC1n, the initialization time may vary.

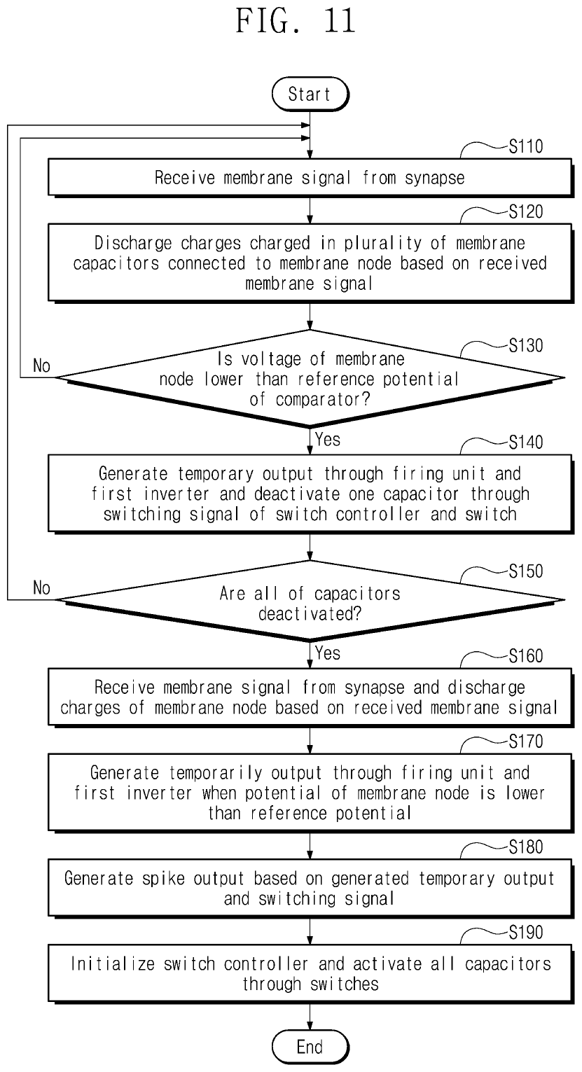

FIG. 11 is a flowchart illustrating the operation sequence of the neuron NU illustrated in FIG. 7, according to an embodiment of the present disclosure. Through FIGS. 7 and 11, the process by which the neuron NU of FIG. 7 receives the membrane signal MS and generates the spike output SO is described.

Referring to FIGS. 7 and 11, in operation S110, the neuron NU may receive the membrane signal MS from the synapse SY. For example, the membrane signal MS may be generated through a weight calculation based on the spike input SP received by the synapse SY.

In operation S120, based on the received membrane signal MS, the neuron NU may discharge charges charged in the plurality of membrane capacitors MC11 to MC1n connected to the membrane node MN. Although the embodiment is described as an example of discharging charges, it may also include the neuron NU that accumulate charges based on membrane signals.

In operation S130, the neuron NU may compare the potential VMN of the membrane node NM with the reference potential Vrefn. When the potential VMN of the membrane node MN is lower than the reference potential Vrefn, the neuron NU may perform operation S140. When the potential VMN of the membrane node MN is not lower than the reference potential Vrefn, the operation returns to operation S110 and the above-described process may be repeated.

In operation S140, the neuron NU may generate the temporary output CO through the firing unit NE and the first inverter INV1. The neuron NU may use the inverted signal of the generated temporary output CO as a clock signal of the switch controller SC. The switch controller SC may respond to the signal in which the temporary output CO is inverted through the second inverter INV2, such that the output nodes SS1 to SSn of the switch controller SC sequentially output and maintain the switching signal.

Based on the switching signal of the output nodes SS1 to SSn of the switch controller SC, the switches S1 to Sn that receive the switching signal may deactivate one of the corresponding plurality of membrane capacitors MC11 to MC1n. For example, when the first switch S1 operates based on a switching signal, the corresponding first membrane capacitor MC11 may be deactivated.

In operation S150, when all of the plurality of membrane capacitors MC11 to MC1n are not deactivated, the neuron NU may return to operation S110 and may repeat the process up to operation S140. For example, when only first membrane capacitor MC11 is deactivated, the neuron NU may repeat operations S110 to S140 described above. The neuron NU may output the switching signal to the second output node SS2 of the switch controller SC in operation S140 and may operate the second switch S2, thereby deactivating the second membrane capacitor MC12. When all the plurality of membrane capacitors MC11 to MC1n are deactivated by repeating the above-described process, the neuron NU may perform operation S160.

In operation S160, the neuron NU may discharge charges from the membrane node MN based on the membrane signal MS, similar to operations S110 and S120. However, unlike the S120 operation in which charges charged in the plurality of membrane capacitors MC11 to MC1n are discharged, operation S160 has some differences in that there is no charge charged in the plurality of membrane capacitors MC11 to MC1n. The neuron NU may discharge charges from the membrane node MN in the form of accumulating negative charges in the plurality of membrane capacitors MC11 to MC1n.

In operation S170, when the potential VMN of the membrane node MN becomes lower than the reference potential Vrefn, the neuron NU may generate the temporarily output CO through the firing unit NE and the first inverter INV1 in the same manner as in operation S140.

In operation S180, the neuron NU may generate the spike output SO based on the generated temporary output CO and the switching signals being output from all output nodes SS1 to SSn of the switch controller SC. For example, the neuron NU may generate the spike output SO through the spike output generator SOG, based on the temporary output CO and the switching signals of the switch controller SC.

In operation S190, the neuron NU may initialize the switch controller SC and may reactivate all the plurality of membrane capacitors MC11 to MC1n. For example, the neuron NU may initialize the switch controller SC by using the spike output SO as the initialization signal of the switch controller SC. The initialized switch controller SC may reactivate all the plurality of membrane capacitors MC11 to MC1n by initializing all the switches S1 to Sn corresponding to the output nodes SS1 to SSn.

When all of the plurality of membrane capacitors MC11 to MC1n are activated through operation S190, the neuron NU may receive the new membrane signal MS from the synapse SY and may repeat the process from operations S110 to S190 described above.

According to an embodiment of the present disclosure, a circuit is provided that may expand the dynamic range of a membrane node while ensuring saturation region operation of a current source of a synapse circuit in a spike neural network implemented with a semiconductor circuit. Based on this, a spike neural network circuit with improved accuracy of charge calculations is provided.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A spike neural network circuit comprising:
an axon configured to generate a spike input;
a synapse configured to perform a weight calculation in response to the spike input and to generate a membrane signal based on the weight calculation; and
a neuron configured to accumulate the membrane signal to generate a spike output, and
wherein the neuron includes:
a firing unit configured to compare a potential of a membrane node where the membrane signal is accumulated with a reference potential, and to fire based on the comparison result;
a plurality of membrane capacitors connected to the membrane node;
a switch controller configured to output a plurality of switching signals based on the firing of the firing unit;
a plurality of switches configured to connect each of the plurality of membrane capacitors to one of a power supply voltage and a ground voltage in response to the switching signals; and
a spike output generator configured to generate the spike output based on the plurality of switching signals and the firing of the firing unit.

2. The spike neural network circuit of claim 1, wherein the neuron further includes:
a first inverter configured to invert an output of the firing unit; and
a second inverter configured to invert an output of the first inverter.

3. The spike neural network circuit of claim 2, wherein the switch controller generates the plurality of switching signals in response to an output of the second inverter.

4. The spike neural network circuit of claim 3, wherein the switch controller includes:
a plurality of flip-flops configured to generate an output signal based on an input signal in response to the output of the first inverter, and
wherein each of the plurality of flip-flops is initialized in response to the spike output,
each of the plurality of flip-flops is connected in cascade, and
outputs of the plurality of flip-flops respectively correspond to the plurality of switching signals.

5. The spike neural network circuit of claim 2, wherein the synapse includes:
a memory configured to store digital weight data;
a current digital-to-analog converter configured to convert the digital weight data into an analog current; and
a synapse calculator configured to transfer the analog current to the neuron as the generated membrane signal in response to the spike input.

6. The spike neural network circuit of claim 2, wherein the firing unit includes:
a comparison unit configured to generate a spike by comparing the reference potential with the potential of the membrane node;
a delay unit configured to generate a delayed signal by a specific time based on the output of the comparison unit; and
an initialization unit configured to initialize the potential of the membrane node to a potential of a power supply node in response to the delayed signal.

7. The spike neural network circuit of claim 2, wherein the reference potential is a value obtained by multiplying a potential of a power supply node by the number of membrane capacitors and then dividing the multiplied result by a value one less than the number of membrane capacitors.

8. A method of operating a spike neural network circuit, the method comprising:
receiving, by a synapse, a spike input from an axon to generate a membrane signal based on a weight;
accumulating the membrane signal on a membrane node of a neuron to lower a potential of the membrane node;
when the potential of the membrane node becomes lower than a reference potential, generating, by a firing unit of the neuron, a firing signal by firing;
generating, by a switch controller, switching signals for deactivating the membrane capacitors in response to the firing signal; and
generating, by a spike output generator, a spike output based on the switching signals and the firing signal.

9. The method of claim 8, wherein the plurality of membrane capacitors are all membrane capacitors with the same electric capacity.

10. The method of claim 8, wherein the reference potential is a value obtained by multiplying a potential of a power supply node by the number of membrane capacitors and then dividing the multiplied result by a value one less than the number of membrane capacitors.
